(19) United States
(12) Patent Application Publication
(10) Pub. No.: US 2024/0190476 A1
(43) Pub. Date: Jun. 13, 2024

(54) METHOD FOR A TRANSPORTATION VEHICLE, METHOD FOR ANOTHER TRANSPORTATION VEHICLE AND CONTROL DEVICE FOR A TRANSPORTATION VEHICLE

(71) Applicant: VOLKSWAGEN AKTIENGESELLSCHAFT, Wolfsburg (DE)

(72) Inventor: Viktor BADER, Wolfsburg (DE)

(21) Appl. No.: 18/533,764

(22) Filed: Dec. 8, 2023

(30) Foreign Application Priority Data
Dec. 8, 2022 (DE) 10 2022 213 280.7

(51) Int. Cl. B60W 60/00

(52) U.S. Cl. CPC B60W 60/0027; B60W 2554/4046; B60W 2555/20; B60W 2556/45; B60W 2720/10; B60W 2754/30

(57) ABSTRACT

A method for a transportation vehicle, a method for a further transportation vehicle, and a control unit for a transportation vehicle. A probability of the occurrence of a driving error or a spontaneous driving maneuver of a driver of another transportation vehicle is determined based on appearances detected and/or behavior of the driver of the other transportation vehicle detected by a surroundings sensor unit of a transportation vehicle and is emitted via a radio system to the vehicle surroundings. The surrounding transportation vehicles receive items of information about potential driving errors or hazardous driving maneuvers originating from the other transportation vehicle which they may not detect from their field of view.

### PRIORITY CLAIM

This patent application claims priority to German Patent Application No. 10 2022 213 280.7, filed Dec. 8, 2022, the disclosure of which is incorporated herein by reference in its entirety.

### SUMMARY

Illustrative embodiments relate to a method for a transportation vehicle, a method for a further transportation vehicle, and a control unit for a transportation vehicle, which is configured to carry out one of the disclosed methods. The transportation vehicle and/or the further transportation vehicle may be self-steering transportation vehicles. The transportation vehicle and/or the further transportation vehicle may also be part of a transportation vehicle fleet.

### BRIEF DESCRIPTION OF THE DRAWINGS

Disclosed embodiments are explained below with reference to the drawings, in which:

FIG. 1 shows a schematic representation of a traffic situation of a transportation vehicle according to an exemplary embodiment;

FIG. 2 shows a schematic representation of a disclosed method according to an exemplary embodiment; and

FIG. 3 shows a schematic representation of a further disclosed method according to an exemplary embodiment.

### DETAILED DESCRIPTION

A driving error which is made or caused by a human as the driver of a transportation vehicle often cannot be predicted or explained on the basis of logical relationships or can only be predicted or explained with great difficulty. In contrast to technical devices, numerous subjective causes exist which can result in an error in a human, so-called human error, and which can hardly be unambiguously or adequately reliably depicted.

Document DE 10 2019 218 455 A1 describes a method for operating a driver assistance device of a transportation vehicle, a driver assistance device, and a transportation vehicle which has at least one driver assistance device. According to the teaching of the cited disclosure, the technical objective is achieved of enabling a realistic prediction of future locations of other road users. For this purpose, a current geographic position of a road user is detected and at least one potential future location of at least one road user is determined according to a predetermined location prediction method. In this case, at least one active profile is assigned to the at least one road user according to a predetermined characterization method from multiple predefined profiles, which each characterize a predetermined acceleration behavior. The transportation vehicle is activated by the driver assistance device depending on the assigned profile and the future movement of the at least one road user derived therefrom.

However, it has been shown that the known driver assistance systems are not capable of recognizing human error sufficiently reliably to initiate an adequate reaction to human error.

The disclosed embodiments provide a method for a transportation vehicle and a control unit for a transportation vehicle which further improve the safety of the road users from human error.

This is achieved by a method for a transportation vehicle, a method for a further transportation vehicle, and a control unit for a transportation vehicle.

A first exemplary embodiment relates to a method for a transportation vehicle. The transportation vehicle may be a transportation vehicle of a fleet made up of transportation vehicles. In a fleet made up of transportation vehicles, the transportation vehicles of the fleet are in radio communication with one another to exchange data packets. The data packets may comprise location data of the transportation vehicles, for example, GPS location data, traffic and/or vehicle surroundings information, and the like, to communicate a current traffic and surroundings situation.

The transportation vehicle comprises a surroundings sensor unit for detecting vehicle surroundings of the transportation vehicle and a radio system having a transceiver and an antenna configured for transmitting and receiving car2X communication signals. The surroundings sensor unit optionally comprises a camera system, which is configured to scan at least some areas of the vehicle surroundings of the transportation vehicle. In other words, images from the surroundings of the transportation vehicle can be created from at least one viewing direction by the surroundings sensor unit. The camera system may be a 3600 camera system. Car2X communication is fundamentally possible by the transmission types WLAN and/or mobile wireless. The WLAN standard for transportation vehicles according to standard IEEE 802.11p in a frequency band from 5.85 GHz to 5.925 GHz may be used for the car2X communication. Other communication standards such as cellular V2X (C-V2X) or 5G (fifth generation of mobile wireless) can also likewise be used, which, in addition to mobile wireless communication, also enable vehicle to vehicle (V2V) communication, thus direct communication. The ranges of WLAN communication can extend up to 1 km in distance. The WLAN radio technology has the benefit over mobile wireless that no further infrastructure is necessary.

In a method operation, an externally visible appearance of a second transportation vehicle and/or an externally visible behavior of a driver of the second transportation vehicle in the vehicle surroundings is detected from the viewing angle of the transportation vehicle using the surroundings sensor unit. In other words, at least one, optionally a plurality of (camera) images is created, which at least partially depict the second transportation vehicle and/or the driver (located in the driver cab) of the second transportation vehicle. A conclusion about a body movement and thus about a behavior of the driver of the second transportation vehicle can be drawn from a plurality of chronologically successive (camera) images.

According to a further operation of the disclosed method, a probability of the occurrence of a driving error and/or a spontaneous driving maneuver of the driver of the second transportation vehicle is determined by comparing the detected appearance and/or the detected behavior of the driver to appearances and/or behaviors stored in a storage unit. The appearances and/or behavior stored in the storage unit may be indicative of a probability of the occurrence of a driving error and/or a spontaneous driving maneuver of a driver of a transportation vehicle. The comparison of the detected appearance and/or the detected behavior of the driver with the stored appearances and/or behaviors likewise may take place using a neural network which was trained by training data to determine a probability for the occurrence of a driving error or a spontaneous driving maneuver of a driver of a transportation vehicle. In at least one exemplary embodiment, the appearance of the second transportation vehicle and/or behavior of the driver detected by the surroundings sensor unit of the transportation vehicle is transmitted using the radio system to an external device, such as a server or a backend, and the determination of the probability is carried out by the external device. The neural network is optionally stored on the external device. The probability determined by the device is then optionally received by the transportation vehicle using the radio system. In this way, computing-intensive operations can be outsourced from the transportation vehicle to an external device. In another exemplary embodiment, the transportation vehicle comprises a control unit which is configured to determine the probability of the occurrence of a driving error or a spontaneous driving maneuver of the driver of the second transportation vehicle.

In a further operation, the determined probability for the occurrence of a driving error and/or a spontaneous driving maneuver of the driver of the second transportation vehicle is emitted using the radio system. Optionally, the determined probability is transmitted to an/the external device and/or to other road users, for example, other transportation vehicles, in the vehicle surroundings. The determined probability depicts a hazard assessment with respect to a/the second transportation vehicle from the field of view or the viewing direction of the transportation vehicle. Each road user typically has a different field of view or a different viewing direction of the second transportation vehicle. Accordingly, a hazard assessment made on the part of the other road users could be different from the probability emitted by the transportation vehicle (lacking complete information). A transportation vehicle driving behind the second transportation vehicle typically only has the view of a rear of the second transportation vehicle driving ahead. A view into the driver cab or of the lateral surfaces of the second transportation vehicle is usually denied to the following transportation vehicle, while a transportation vehicle from the oncoming traffic or a transportation vehicle driving laterally toward the road can see the driver cab and/or a lateral surface of the transportation vehicle. The occurrence of incorrect hazard assessments can be reduced and the traffic safety can be improved by the emission or mutual exchange of the determined probabilities. In other words, the surrounding road users can receive information about potential driving errors or hazardous driving maneuvers originating from the second transportation vehicle, which they possibly cannot or could not detect from their field of view.

In at least one exemplary embodiment, it is provided that the determination of the probability for an occurrence of a driving error and/or a spontaneous driving maneuver of the driver of the second transportation vehicle is carried out based on an object attached or applied to or displayed on the vehicle outer skin and/or an object visible from the outside in the interior of the transportation vehicle, such as a detected inscription, a detected logo or symbol, a detected sticker, a detected warning, and/or a detected additionally attached vehicle part of the second transportation vehicle. The object can also be displayed on a display and/or a light element of the transportation vehicle. For example, on a display which is oriented outward viewed from the transportation vehicle, in particular, to be seen from the vehicle surroundings. Examples of an inscription are characters, lettering, and/or symbols, which are arranged on the surface of the second transportation vehicle, for example, on a vehicle body part and/or a vehicle window. The conceptual content of the inscriptions can be determined by text and image recognition and a hazard assessment can be derived therefrom. This applies analogously for stickers and warnings. Warnings usually contain standardized characters, symbols, shapes, and/or colors, which can be evaluated particularly easily. For example, lettering can be recognized on a lateral surface of the second transportation vehicle, which contains a notification of a rental vehicle, a driving school vehicle, or the like. In this case, it can be presumed with increased probability that the driver of the second transportation vehicle will very probably be unpracticed in driving their present transportation vehicle, so that the probability of the occurrence of a driving error or a spontaneous driving maneuver of the driver is increased. In contrast, for example, if no front passenger is recognized in a detected driving school vehicle, this vehicle can thus be classified as a regular transportation vehicle since it can be presumed that a driving student is not seated behind the controls of the vehicle. Examples of additionally attached vehicle parts are safety-relevant special equipment, such as additional side mirrors, or also a coupled-on trailer. A driving school vehicle or a transportation vehicle having a trailer may be concluded on the basis of the additional side mirrors. Driving a transportation vehicle having a trailer is fundamentally more challenging and therefore requires a certain degree of experience. In particular, when cornering on multilane roads, it often occurs with unexperienced drivers that their vehicle combination penetrates into an adjacent lane and therefore represents an increased safety risk. In particular, the combination of trailer and detected inscription on the trailer, from which a driving school or a rental trailer may be concluded, represents a particular hazard for the occurrence of a driving error and/or a spontaneous driving maneuver.

In a further exemplary embodiment, it is provided that the determination of the probability of an occurrence of a driving error and/or a spontaneous driving maneuver of the driver of the second transportation vehicle is carried out based on a detected vehicle type, motor vehicle license plate, and/or a detected loading state of the second transportation vehicle. A rough (pre)assessment can be carried out on the basis of the detected vehicle type, which is fast and less computing-intensive. The transportation vehicle license plate typically contains information about the registration country and the location of the registration of the transportation vehicle. Conclusions can be drawn from the information about whether the second transportation vehicle is a foreign transportation vehicle. Drivers of foreign transportation vehicles typically are not very familiar with the present surroundings and therefore have an increased tendency toward driving errors. Foreign means a distance difference from the location of the registration and the present location of more than 50 km, optionally more than 100 km. Using location information from the (ego) transportation vehicle, obtained, for example, by GPS from a navigation system of the transportation vehicle and the transportation vehicle license plate, the second transportation vehicle can be determined as foreign. A loading state of the second transportation vehicle can also have an influence on driving errors. A fully loaded transportation vehicle is heavier in comparison to a regular (unloaded) transportation vehicle and therefore has different (unfamiliar) driving properties, for example, increased inertia, which results in different cornering behavior, longer braking distances, and the like, and moreover the view of the driver of the fully loaded transportation vehicle can be at least partially blocked or restricted by the cargo.

In a further exemplary embodiment, it is provided that the determination of the probability of an occurrence of a driving error and/or a spontaneous driving maneuver of the driver of the second transportation vehicle is carried out based on a time of day, a day of the week, the weather, and/or visibility conditions. The present time of day and/or the present day of the week can have an influence on the decision as to whether the determined probability for an occurrence of a driving error and/or a spontaneous driving maneuver of the driver of the second transportation vehicle is increased, decreased, or remains the same. For example, a detected driving school vehicle will only be used for the purpose of a driving school lesson with reduced probability on a Sunday. The present weather, in particular, rain (aquaplaning) or snow (hazard of slipping), and/or the present visibility conditions, in particular, fog or low-lying sun, generally result in an increased occurrence of driving errors and/or spontaneous driving maneuvers.

In a further exemplary embodiment, it is provided that the determination of the probability of the occurrence of a driving error and/or a spontaneous driving maneuver of the driver of the second transportation vehicle is carried out based on a detected body movement of the driver of the second transportation vehicle and/or a detected object held by the driver of the second transportation vehicle. Excessive gesticulations and/or strong head movements of the driver of the second transportation vehicle permit it to be concluded that the driver is partially distracted, therefore is not completely concentrating on driving the transportation vehicle. A further distraction of the driver of the second transportation vehicle is formed by the interaction with an object held in the hand such as a telephone, a smartphone, a cigarette, a coffee cup, and the like.

In a further exemplary embodiment it is provided that the transportation vehicle furthermore comprises a driver assistance system for autonomous intervention in the driving operation of the transportation vehicle. In a further method operation, it is then provided that an intervention in the driving operation of the transportation vehicle is carried out using the driver assistance system and in consideration of the determined probability. An intervention in the driving operation of the transportation vehicle optionally takes place as soon as the determined probability exceeds a predefined probability threshold. The driver assistance system may be configured to semiautonomously or fully autonomously take over driving tasks. The radio system of the transportation vehicle may be configured to receive one or a plurality of acquired externally visible appearances of the second transportation vehicle, an externally visible behavior of the driver of the second transportation vehicle, and/or a determined probability of the occurrence of a driving error or a spontaneous driving maneuver of the driver of the second transportation vehicle from another transportation vehicle and to take them into consideration when carrying out the intervention in the driving operation of the transportation vehicle. The safety for the transportation vehicle may, therefore, be improved.

In a further exemplary embodiment, it is provided that the intervention in the driving operation of the transportation vehicle takes place such that a distance to the second transportation vehicle is increased and/or a velocity of the transportation vehicle is decreased. In particular, an increased (safety) distance is maintained to the second transportation vehicle. The increased distance may be correlated with the determined probability. This means that the more probable the occurrence of a driving error or a spontaneous driving maneuver of the driver of the second transportation vehicle is, the greater the distance to the second transportation vehicle is selected. With the (safety) distance selected selectively for each transportation vehicle in the vehicle surroundings, on the one hand, the safety for the transportation vehicle is improved and, on the other hand, a space requirement of the transportation vehicle on the provided road is minimized.

A further exemplary embodiment relates to a method for a further transportation vehicle. The further transportation vehicle comprises a driver assistance system for autonomously intervening in the driving operation of the further transportation vehicle and a radio system having a second transceiver and an antenna configured for transmitting and receiving car2X communication signals. The driver assistance system and/or the radio system may be designed like the above-described driver assistance system and the above-described radio system.

According to the method, a determined probability of the occurrence of a driving error and/or a spontaneous driving maneuver of a driver of a second transportation vehicle is received using the radio system. The received determined probability may originate from the above-mentioned transportation vehicle and/or from the above-mentioned external device. In a further operation of the method, an intervention in the driving operation of the further transportation vehicle is carried out using the driver assistance system and in consideration of the received determined probability.

In at least one exemplary embodiment, the further transportation vehicle furthermore comprises a surroundings sensor unit for detecting vehicle surroundings of the further transportation vehicle. According to one method operation, an externally visible appearance of a second transportation vehicle and/or an externally visible behavior of a driver of the second transportation vehicle in the vehicle surroundings is detected from the viewing angle of the further transportation vehicle using the surroundings sensor unit. The second transportation vehicle may be the above-mentioned second transportation vehicle. In a further method operation, the probability of the occurrence of a driving error and/or a spontaneous driving maneuver of the driver of the second transportation vehicle is verified and/or corrected by comparing the appearance detected by the further transportation vehicle and/or the behavior of the driver detected by the further transportation vehicle to appearances and/or behaviors stored in a storage unit. A correction of the determined probability may be only carried out when the (newly) determined probability is greater than the prior (for example, received) probability. This prevents an incorrect hazard assessment because of a lack of complete information, i.e., a hazard not recognizable from the viewing angle of the further transportation vehicle, from incorrectly overwriting a hazard already determined from another transportation vehicle (from another viewing angle). In a further method operation, the verified and/or corrected probability of the occurrence of a driving error and/or a spontaneous driving maneuver of the driver of the second transportation vehicle is emitted using the radio system. The determined probability can therefore be checked in the fleet from vehicle to vehicle and passed on verified and/or corrected, i.e., optimized.

The transportation vehicle and the further transportation vehicle may form a system of transportation vehicles, in particular, a fleet of transportation vehicles, which are in radio communication with one another. In this case, the method is suitable for a fleet of transportation vehicles.

A further exemplary embodiment relates to a control unit (controller) for a transportation vehicle, which is configured to carry out one or both of the above-mentioned methods. The transportation vehicle may be designed as the above-described transportation vehicle or as the above-described further transportation vehicle. The optional features described with the methods and the benefits thereof may be implemented analogously using the control unit and may therefore be combined with one another arbitrarily.

The above-mentioned control unit may be implemented by electrical or electronic parts or components (hardware) or by firmware (ASIC). Additionally or alternatively, the functionality of the control unit is implemented upon execution of a suitable program (software). The control unit may be implemented by a combination of hardware, firmware, and/or software. For example, individual components of the control unit for providing individual functionalities are designed as a separately integrated circuit or are arranged on a common integrated circuit.

The individual components of the control unit may be designed as one or more processes which run on one or more processors in one or more electronic computing devices and are generated upon execution of one or more computer programs. The computing devices may be designed here to cooperate with other components, such as a communication system, a driver assistance system, or a motor controller, to implement the functionalities described herein. The instructions of the computer programs may be stored in a memory here, such as a RAM element. However, the computer programs can also be stored in a nonvolatile storage medium, such as a CD-ROM, a flash memory, or the like.

It is furthermore apparent to a person skilled in the art that the functionalities of multiple computing units (data processing devices) can be combined or can be combined in a single device or that the functionality of a specific data processing device can be provided distributed on a plurality of devices to implement the functionality of the control unit.

A further exemplary embodiment relates to a computer program, comprising commands which, upon the execution of the program by a computer, such as a control unit for a transportation vehicle comprising a surroundings sensor unit for detecting vehicle surroundings of the transportation vehicle and a radio system having a transceiver and an antenna configured for transmitting and receiving car2X communication signals or for a further transportation vehicle having a driver assistance system for autonomous intervention in the driving operation of the further transportation vehicle and a radio system having a second transceiver and an antenna configured for transmitting and receiving car2X communication signals, prompt the computer to carry out one or both of the disclosed methods, in particular, a method for a transportation vehicle or a further transportation vehicle.

The various embodiments disclosed in this application can be combined with one another, if not stated otherwise in the specific case.

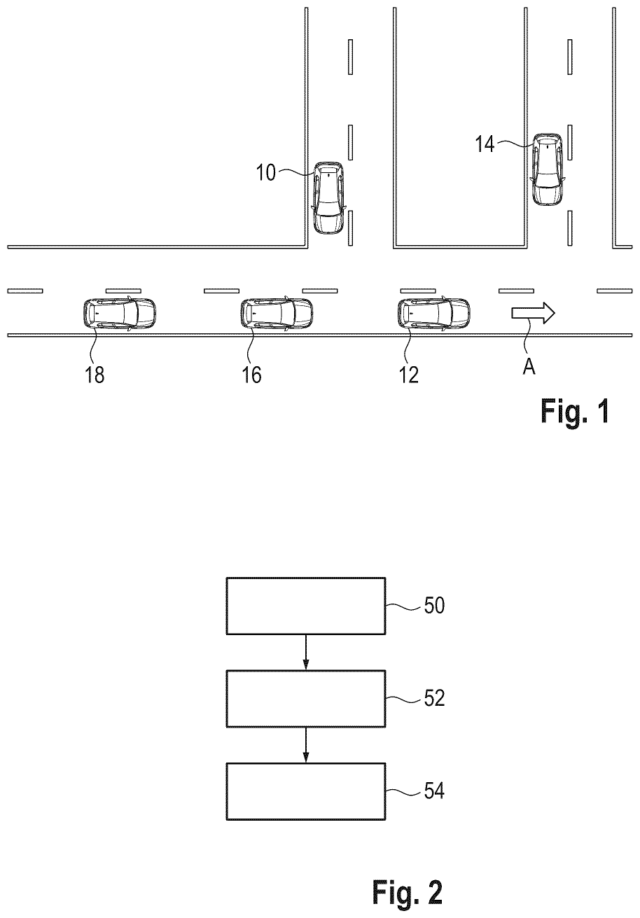

FIG. 1 shows a schematic representation of a traffic situation of an exemplary fleet made up of a transportation vehicle 10 according to at least one disclosed embodiment and further transportation vehicles 14, 16, 18. The transportation vehicles 10, 14, 16, 18 of the fleet are designed by way of example as self-steering transportation vehicles and each comprise a surroundings sensor unit for detecting vehicle surroundings, an autonomous driver assistance system for autonomous intervention in the driving operation of the respective transportation vehicle 10, 14, 16, 18, a radio system having a transceiver and an antenna configured for transmitting and receiving car2X communication signals, and a control unit. The surroundings sensor unit of the transportation vehicles 10, 14, 16, 18 has in each case a plurality of vehicle surroundings sensors for scanning vehicle surroundings. The plurality of vehicle surroundings sensors are designed as a 360° camera system. The control unit is connected in each case to the driver assistance system, the radio system, and the plurality of vehicle surroundings sensors.

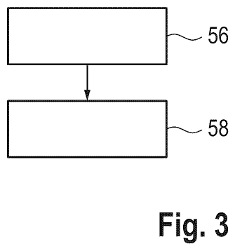

FIG. 1 furthermore shows a second transportation vehicle 12, which is driven (manually) by a driver. The second transportation vehicle 12 is therefore not a self-steering transportation vehicle or in the present case it is at least not driven in a self-steering manner. In principle, the second transportation vehicle 12 is thus susceptible to human error and therefore represents a potential (unpredictable) hazard for the transportation vehicles 10, 14, 16, 18 of the fleet. To be able to better assess the potential hazard originating from the second transportation vehicle 12, the transportation vehicles 10, 14, 16, 18 of the fleet communicate with one another via their radio systems and exchange items of information with one another. The communication and the respective hazard assessment will be explained in more detail with reference to FIGS. 2 and 3.

The traffic situation shown by way of example in FIG. 1 is as follows: A vehicle column 12, 16, 18, led by the manually driven second transportation vehicle 12, drives along a road in a travel direction indicated by the arrow A. The second transportation vehicle 12 is followed by two further self-steering transportation vehicles 16 and 18. The one further transportation vehicle 16, which directly follows the second transportation vehicle 12, has at least a free view of the rear of the second transportation vehicle 12, while a view of a lateral surface or of a front part, in particular, into the driver cab, of the second transportation vehicle 12 is not possible or is only possible in a very restricted manner. The rear further transportation vehicle 18 of the two further transportation vehicles 16, 18 of the vehicle column 12, 16, 18, in contrast, has no view at all of the second transportation vehicle 12. This transportation vehicle 18 can, therefore, only react very late to a possible driving error or a spontaneous driving maneuver of the driver of the second transportation vehicle 12, such as strong braking or a spontaneous change of the lane.

The transportation vehicle 10 stands on one of the roads which orthogonally intersects the road traveled by the vehicle column. The field of view of the transportation vehicle 10 comprises a free view of a lateral surface of the second transportation vehicle 12 and partially into its driver cab. A further transportation vehicle 14 of the fleet approaches the road traveled by the vehicle column 12, 16, 18 in the parallel direction to the transportation vehicle 10. Since the further transportation vehicle 14 is at a greater distance than the transportation vehicle 10 along the travel direction A of the vehicle column, the further transportation vehicle 14 has a free field of view of a front part of the second transportation vehicle 12 and into its driver cab. Solely by way of example, the second transportation vehicle 12 is a rental vehicle, which comprises inscriptions on the lateral surfaces—well recognizable from the viewing angle of the transportation vehicle 10—which give an indication that the second transportation vehicle 12 is a rental vehicle. For example, an inscription “hire me” or “rent me” or a symbol indicative of a rental vehicle, such as a company logo of a car rental company, is arranged on the lateral surfaces. It can be presumed with higher probability in the case of rental vehicles that the driver of the second transportation vehicle 12 will very probably be unpracticed in dealing with the rental vehicle, so that the probability of the occurrence of a driving error or a spontaneous driving maneuver of the driver is increased. In addition, the driver of the second transportation vehicle 12 holds, by way of example, a telephone in their right hand at their right ear, by which the probability of the occurrence of a driving error or a spontaneous driving maneuver of the driver is further increased due to the distraction. This circumstance is not recognizable in the traffic situation shown, for example, for the transportation vehicle 10, i.e., from the viewing angle of the transportation vehicle 10 and is only recognizable for the further transportation vehicle 14. The further transportation vehicles 16, 18 of the vehicle column 12, 16, 18 cannot see the inscription of the second transportation vehicle 12 or the telephoning of the driver of the second transportation vehicle 12. Accordingly, from their viewing angles, there is no increased probability of the occurrence of a driving error or a spontaneous driving maneuver of the driver of the second transportation vehicle 12. However, this is a fatal incorrect hazard assessment.

FIG. 2 shows a schematic representation of a method for a transportation vehicle 10 according to at lest one disclosed embodiment. The transportation vehicle 10 is the transportation vehicle 10 shown in FIG. 1. The transportation vehicle 10 comprises a control unit which is configured to carry out the method according to FIG. 2.

According to a first method operation at 50 of the method, an externally visible appearance of the second transportation vehicle 12 in the vehicle surroundings is detected from the viewing angle of the transportation vehicle 10 using the surroundings sensor unit of the transportation vehicle 10. The inscription on the lateral surface of the second transportation vehicle 12 is recognized by text and image recognition and the information that the second transportation vehicle 12 is a rental vehicle is extracted.

In a second method operation at 52, a probability of the occurrence of a driving error or a spontaneous driving maneuver of the driver of the second transportation vehicle 12 is determined by comparing the detected appearance to appearances and behaviors stored in a storage unit. An increased probability of the occurrence of a driving error or a spontaneous driving maneuver is stored in the storage unit for the information “rental vehicle”.

In a third method operation at 54, the determined probability for the occurrence of a driving error or a spontaneous driving maneuver of the driver of the second transportation vehicle 12 is emitted using the radio system to the further transportation vehicles 14, 16, 18.

FIG. 3 shows a schematic representation of a further method for a further transportation vehicle 14, 16, 18 according to at least one disclosed embodiment. The further transportation vehicle 14, 16, 18 is one of the transportation vehicles 14, 16, 18 shown in FIG. 1. The further transportation vehicle 14, 16, 18 comprises a control unit which is configured to carry out the method according to FIG. 3.

According to a first method operation at 56 of the method for a further transportation vehicle 14, 16, 18, the determined probability of the occurrence of a driving error and a spontaneous driving maneuver of the driver of the second transportation vehicle 12 is received using the radio system from the transportation vehicle 10.

In a second method operation at 58, an intervention is carried out in the driving operation of the further transportation vehicle 14, 16, 18 using the driver assistance system and in consideration of the received determined probability. For this purpose, a (preset) safety distance to be maintained to the second transportation vehicle 12 is increased.

The method described in FIG. 2 is also carried out by the further transportation vehicles 14, 16, 18, so that each transportation vehicle 10, 14, 16, 18 of the fleet determines a probability of the occurrence of a driving error and a spontaneous driving maneuver of the driver of the second transportation vehicle 12. No increased probability is established in the case of the further transportation vehicles 16, 18 of the vehicle column.

In the case of the further transportation vehicle 14, which has a view into the driver cab of the second transportation vehicle 12, an externally visible behavior of the driver of the second transportation vehicle 12—telephoning with the telephone in the right hand—is detected using the surroundings sensor unit of the further transportation vehicle 14. By comparing the detected behavior of the driver to behaviors stored in a storage unit of the further transportation vehicle 14, the probability of the occurrence of a driving error or a spontaneous driving maneuver of the driver of the second transportation vehicle 12 is determined. The probability thus determined is compared to the determined probability received from the transportation vehicle 10. Since the cause of the increased probability is different, the received probability is applied to the probability determined by the transportation vehicle 14, i.e., added, to obtain a further increased probability of the occurrence of a driving error or a spontaneous driving maneuver of the driver of the second transportation vehicle 12. This is then emitted using the radio system of the further transportation vehicle 14 to the transportation vehicle 10 and the further transportation vehicles 16, 18 of the fleet. As a result, the transportation vehicles 10, 14, 16, 18 can carry out appropriate safety measures on the basis of the determined further increased probability to further improve the safety of the road users from human error.

It is obvious that the above-described scenario only represents an exemplary embodiment and this disclosure is not restricted to this scenario.

### LIST OF REFERENCE SIGNS

10 transportation vehicle
12 second transportation vehicle
14, 16, 18 further transportation vehicles
arrow A direction of travel of second transportation vehicle
50 first method operation (transportation vehicle)
52 second method operation (transportation vehicle)
54 third method operation (transportation vehicle)
56 first method operation (further transportation vehicle)
58 second method operation (further transportation vehicle)

1. A control unit for a transportation vehicle that includes a surroundings sensor unit that detects vehicle surroundings and a radio system having a transceiver and an antenna for transmitting and receiving car2X communication signals, wherein the control unit controls:
detection of an externally visible appearance of a second transportation vehicle and/or an externally visible behavior of a driver of the second transportation vehicle in the vehicle surroundings from a viewing angle of the transportation vehicle using the surroundings sensor unit;
determination of a probability of occurrence of a driving error and/or a spontaneous driving maneuver of the driver of the second transportation vehicle by comparing the detected appearance and/or the detected behavior of the driver of the second transportation vehicle to appearances and/or behaviors stored in a storage unit; and
emission of the determined probability of the occurrence of a driving error and/or a spontaneous driving maneuver of the driver of the second transportation vehicle using the radio system.

2. The control unit of claim 1, wherein the determination of the probability of an occurrence of a driving error and/or a spontaneous driving maneuver of the driver of the second transportation vehicle is performed based on a detected inscription, a detected sticker, a detected warning, and/or a detected additionally attached vehicle part of the second transportation vehicle.

3. The control unit of claim 1, wherein the determination of the probability of an occurrence of a driving error and/or a spontaneous driving maneuver of the driver of the second transportation vehicle is performed based on a detected vehicle class, motor vehicle license plate, and/or loading status of the second transportation vehicle.

4. The control unit of claim 1, wherein the determination of the probability of an occurrence of a driving error and/or a spontaneous driving maneuver of the driver of the second transportation vehicle is performed based on a time of day, a day of the week, the weather, and/or visibility conditions.

5. The control unit of claim 1, wherein the determination of the probability of the occurrence of a driving error and/or a spontaneous driving maneuver of the driver of the second transportation vehicle is performed based on a detected body movement of the driver of the second transportation vehicle and/or a detected object held by the driver of the second transportation vehicle.

6. The control unit of claim 1, wherein the transportation vehicle further comprises a driver assistance system for autonomous intervention in the driving operation of the transportation vehicle, wherein the control unit controls the driver assistance system to carry out an intervention in the driving operation of the transportation vehicle based on the determined probability.

7. The control unit of claim 6, wherein the driving operation intervention comprises increasing a distance to the second transportation vehicle and/or decreasing a velocity of the transportation vehicle.

8. The control unit of claim 1, wherein the transportation vehicle further comprises a driver assistance system for autonomous intervention in the driving operation of the further transportation vehicle and a radio system having a second transceiver and an antenna for transmitting and receiving car2X communication signals, wherein the control unit controls:
receipt of a determined probability of an occurrence of a driving error and/or a spontaneous driving maneuver of a driver of a second transportation vehicle using the radio system; and
performing an intervention in the driving operation of the further transportation vehicle using the driver assistance system based at least on the received determined probability.

9. The control unit of claim 8, wherein the second transportation vehicle also includes a surroundings sensor unit that detects vehicle surroundings of the second transportation vehicle, wherein the control unit of the transportation vehicle controls:
verification and/or correction of a probability of occurrence of a driving error and/or a spontaneous driving maneuver of the driver of the second transportation vehicle by comparing the detected appearance and/or the detected behavior of the driver to appearances and/or behaviors stored in a storage unit; and
emission of the verified and/or corrected probability of the occurrence of a driving error and/or a spontaneous driving maneuver of the driver of the second transportation vehicle using the radio system.

10. A method for a transportation vehicle, wherein the transportation vehicle comprises a surroundings sensor unit for detecting vehicle surroundings of the transportation vehicle and a radio system having a transceiver and an antenna for transmitting and receiving car2X communication signals, the method comprising:
detecting an externally visible appearance of a second transportation vehicle and/or an externally visible behavior of a driver of the second transportation vehicle in the vehicle surroundings from the viewing angle of the transportation vehicle using the surroundings sensor unit;
determining a probability of the occurrence of a driving error and/or a spontaneous driving maneuver of the driver of the second transportation vehicle by comparing the detected appearance and/or the detected behavior of the driver to appearances and/or behaviors stored in a storage unit; and
emitting the determined probability of the occurrence of a driving error and/or a spontaneous driving maneuver of the driver of the second transportation vehicle using the radio system.

11. The method of claim 10, wherein the determination of the probability of an occurrence of a driving error and/or a spontaneous driving maneuver of the driver of the second transportation vehicle is performed based on a detected inscription, a detected sticker, a detected warning, and/or a detected additionally attached vehicle part of the second transportation vehicle.

12. The method of claim 10, wherein the determination of the probability of an occurrence of a driving error and/or a spontaneous driving maneuver of the driver of the second transportation vehicle is performed based on a detected vehicle class, motor vehicle license plate, and/or loading status of the second transportation vehicle.

13. The method of claim 10, wherein the determination of the probability of an occurrence of a driving error and/or a spontaneous driving maneuver of the driver of the second transportation vehicle is performed based on a time of day, a day of the week, the weather, and/or visibility conditions.

14. The method of claim 10, wherein the determination of the probability of the occurrence of a driving error and/or a spontaneous driving maneuver of the driver of the second transportation vehicle is performed based on a detected body movement of the driver of the second transportation vehicle and/or a detected object held by the driver of the second transportation vehicle.

15. The method of claim 10, wherein the transportation vehicle further includes a driver assistance system for autonomous intervention in the driving operation of the transportation vehicle, the method further comprising performing intervention in the driving operation of the transportation vehicle using the driver assistance system based on the determined probability.

16. The method of claim 15, wherein the driving operation intervention increases a distance to the second transportation vehicle and/or decreasing a velocity of the transportation vehicle.

17. A method for a further transportation vehicle, wherein the further transportation vehicle has a driver assistance system for autonomous intervention in the driving operation of the further transportation vehicle and a radio system having a second transceiver and an antenna for transmitting and receiving car2X communication signals, the method comprising:
receiving a determined probability of the occurrence of a driving error and/or a spontaneous driving maneuver of a driver of a second transportation vehicle using the radio system;
carrying out an intervention in the driving operation of the further transportation vehicle using the driver assistance system and taking into account the received determined probability.

18. The method of claim 17, wherein the second transportation vehicle further comprises a surroundings sensor unit for detecting vehicle surroundings of the second transportation vehicle, the method further comprising:
detecting an externally visible appearance of a second transportation vehicle and/or an externally visible behavior of a driver of the second transportation vehicle in the vehicle surroundings from the viewing angle of the further transportation vehicle using the surroundings sensor unit;
verifying and/or correcting the probability of the occurrence of a driving error and/or a spontaneous driving maneuver of the driver of the second transportation vehicle by comparing the detected appearance and/or the detected behavior of the driver to appearances and/or behaviors stored in a storage unit; and
emitting the verified and/or corrected probability of the occurrence of a driving error and/or a spontaneous driving maneuver of the driver of the second transportation vehicle using the radio system.
